(19) United States
(12) Patent Application Publication
(10) Pub. No.: US 2019/0287060 A1
(43) Pub. Date: Sep. 19, 2019

(54) IMPLEMENTATION OF PIPE IDENTIFICATION AND TRACKING SYSTEM

(71) Applicant: ULTRA PREMIUM SERVICES, L.L.C., Houston, TX (US)

(72) Inventors: Christopher Tu Tran, Houston, TX (US); Curtis Matthew Potts, Regina (CA)

(73) Assignee: ULTRA PREMIUM SERVICES, L.L.C., Houston, TX (US)

(21) Appl. No.: 16/402,732

(22) Filed: May 3, 2019

Related U.S. Application Data
(63) Continuation-in-part of application No. 16/162,881, filed on Oct. 17, 2018.
(60) Provisional application No. 62/573,471, filed on Oct. 17, 2017.

(51) Int. Cl. G06Q 10/08; G06K 19/07; G06K 19/077; G06F 16/26

(52) U.S. Cl. CPC G06Q 10/0833; G06F 16/26; G06K 19/07749; G06K 19/0723

(57) ABSTRACT

Techniques involve implementing systems and methods for identifying and tracking tubular goods. One or more embodiments involve generating a pipe ID for a pipe. The pipe ID is associated with information concerning one or more characteristics of the pipe. Testing may be performed on the pipe to generate testing results, and these testing results are further associated with the pipe ID. An external identifier may be attached to the pipe. The external identifier is associated with the pipe ID, and the pipe ID is saved in a database. The database may be accessed to save further pipe information associated with the pipe ID, or accessed to acquire the pipe information associated with a particular pipe ID.

### TECHNICAL FIELD

The present application relates to tracking systems, and more particularly, to identification and tracking systems for tubular goods.

### BACKGROUND

This section is intended to introduce various aspects of art that may be related to various aspects of the present techniques, which are described and/or claimed below. This discussion is believed to be helpful in providing background information to facilitate a better understanding of the various aspects of the present disclosure. Accordingly, it should be understood that these statements are to be read in this light, and not as admissions of prior art. The following descriptions and examples are not admitted to be prior art by virtue of their inclusion in this section.

The oil and gas industry is drilling upstream production wells of increasing depth and complexity to find and produce raw hydrocarbons. The industry routinely uses steel pipe, considered an Oil Country Tubular Good (OCTG) to protect the borehole (i.e., casing) and to control the fluids produced within the pipe (i.e., tubing). Such tubular goods, including casing and tubing, are made and transported in relatively short segments and installed in the borehole one segment at a time, with each segment being connected to the next. Similar steel pipes are also used for other applications, including line pipe which is used in pipeline construction.

Depending on the different environments of a borehole, conditions for production, and other demands of a customer, various types of pipe may be ordered and transported. Additionally, large quantities of pipe may be needed for relatively deeper wells. The large quantity and variety of tubular goods may result in logistical challenges in the OCTG industry. For example, manufacturers, distributors, and end users may all benefit from more efficient techniques for identifying and tracking pipe. Systems for efficiently identifying various attributes of a segment of pipe, and tracking its source, location, and destination may be developed to meet industry demands.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one embodiment, an identification and tracking system includes a non-transitory tangible computer-readable storage medium having executable computer code stored thereon, the code comprising instructions that causes one or more processors to generate a pipe ID to be correlated with a pipe. The pipe ID is unique to the pipe. The one or more processors further accept pipe information specific to the pipe and identify the pipe information specific to the pipe with the pipe ID. The processors also output the pipe ID and associated pipe information to a database configured to store multiple pipe IDs and output pip information associated with one or more requested pipe IDs.

In some embodiments, the identification and tracking system stores pipe information including pipe dimensions, pipe composition, pipe treatment details, pipe testing results, pipe order number, bill of lading number, pipe manufacturing location, pipe treatment location, pipe delivery destination, or combinations thereof. The system may be configured to accept one or more components of pipe information at different times, and associate the one or more components of pipe information with the pipe ID. The system may further include an external identifier configured to be affixed to the pipe and read by a reader. The reader is configured to read the external identifier and transmit pipe information to the one or more processors, such that the pipe information is accepted and associated with the pipe ID.

In another embodiment, a method includes generating a pipe ID for a pipe. The pipe ID is unique to the pipe. The method further includes performing testing on the pipe to generate testing results, and associating testing results with the pipe ID. An external identifier is attached to the pipe and associated with the pipe ID. The pipe ID is then saved in a database.

In some embodiments, associating testing results with the pipe ID includes associating testing parameters, testing descriptions, testing types, testing passage, testing results, or combinations thereof, with the pipe ID. Associating testing results with the pipe ID comprises associating testing parameters, testing descriptions, testing types, testing passage, testing results, or combinations thereof, with the pipe ID. In some embodiments, attaching the external identifier involves attaching an RFID tag to the pipe. Further, in some embodiments, the method further includes scanning the external identifier prior to shipping the pipe. Scanning the external identifier results in shipment information, which is further associated with the pipe ID.

### BRIEF DESCRIPTION OF THE DRAWINGS

Embodiments of the present techniques are described with reference to the following figures. The same numbers are used throughout the figures to reference like features and components. Various embodiments may utilize elements and/or components other than those illustrated in the drawings, and some elements and/or components may not be present in various embodiments. Elements and/or components in the figures are not necessarily drawn to scale.

FIG. 1 is a schematic diagram of a tubular goods identification and tracking system;

FIG. 2 is a block diagram representing a method for implementing a system for identifying and tracking tubular goods;

FIG. 3 is another block diagram representing a method for accessing information and tracking tubular goods using the system;

FIG. 4 is a screenshot of a web application integrated with embodiments of the present techniques; and

FIGS. 5A-5C are screenshots of a mobile application integrated with embodiments of the present techniques.

FIGS. 6A-6C are screenshots of a mobile application integrated with embodiments of the present techniques.

### DETAILED DESCRIPTION

A large quantity and variety of tubular goods are produced, sold, and used in many industries, such as oil and gas, construction, water transport, automotive, agricultural, fluid power industries, etc. Identifying and tracking tubular goods throughout their manufacture, quality testing, shipment, and use may result in increased efficiencies and more accurate inventory control for manufacturers, deliverers, distributors, and end users of tubular goods. Tubular goods may refer to tubing, casing, drill pipe, line pipe, other OCTG products or American Society for Testing and Materials (ASTM) products, hollow structural sections (HSS), etc., and may be referred to as simply “pipe.” Tubular goods or pipe may include any tubular metal having a hollow cross section.

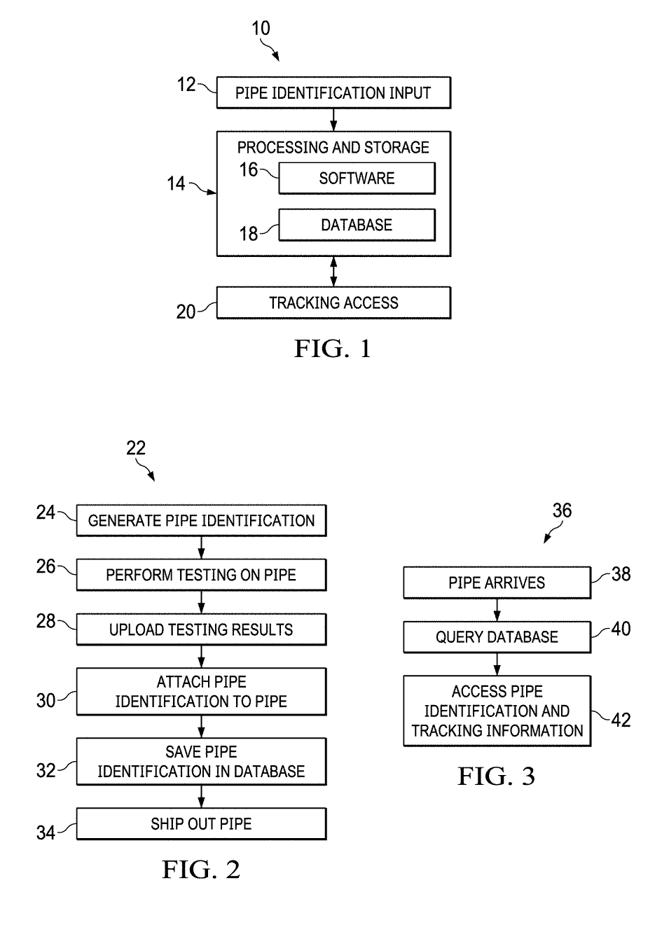

The schematic diagram of FIG. 1 includes components which may be used in a system for identifying and tracking tubular goods. Generally speaking, each pipe is assigned a unique pipe ID at or near the beginning of the manufacturing process, which is then associated with various items of pipe identification information and used to track each pipe and/or retrieve the associated pipe identification information, all of which is explained below in further detail.

FIG. 2 is a block diagram representing a method 22 for implementing a system for identifying and tracking tubular goods as they are manufactured. The method 22 begins with generating (block 24) a pipe identification (pipe ID) for a particular length of pipe. Generating (block 24) the pipe ID may occur while or around when the pipe is manufactured. The pipe ID may initially include a coil number, a batch or work order number, a pipe type, and/or the name of the plant in which the pipe has been manufactured. In one embodiment, a coil number may be input into an automated system which will then generate a new pipe ID each time steel is cut from the coil to form a new pipe. The pipe ID is entered into a database, where it is associated with various items of pipe identification information, as explained in more detail below.

As the pipe is manufactured, a barcode or other unique external identifier may also be applied to the pipe. The unique external identifier may be used to associate a particular pipe with its assigned pipe ID. In some embodiments, the unique external identifier may be used to identify a pipe during the manufacturing process, such that more information about the pipe may be properly input to the pipe's pipe ID.

For certain types of pipe, the unique external identifier may be in the form of an RFID tag, which may include a bar code or QR code, applied to the interior or exterior surface of the pipe. If an RFID tag is applied as the unique external identifier during the manufacturing process, the tag may be formed of a heat-resistant material to ensure that it is not damaged during the remaining portions of the manufacturing process or during its use in the field.

For certain types of pipe, the unique external identifier may be in the form of a stencil on the side of the pipe. In such an embodiment, the stencil may be replaced by an RFID tag, which may include a bar code or QR code, at or near the conclusion of the manufacturing process. For example, an RFID tag may be placed on the end cap which is affixed to the pipe before it is shipped out to a customer. In such an embodiment, other methods of applying a unique external identifier may be used when the end caps and RFID tags are removed from the pipe after it has been delivered to the customer. For example, laser etching may be used to apply a similar bar code or even simply to replicate the pipe ID similar to the stencil that was used during the manufacturing process.

The system 10 includes means for inputting (block 12) of pipe identification information. For example, pipe identification information may include a batch number, any associated sales order number, a location in which it was manufactured, tested, and/or treated, dimension information such as length, diameter, weight, material, and any other relevant information on the characteristics of the pipe. In addition, once a pipe has been manufactured and a pipe ID has been generated (block 24) for the pipe, various tests may be performed (block 26) on the pipe. For example, the pipe may undergo a hydrotester to test its performance under water pressure. Non-destructive testing (e.g., electromagnetic, ultrasonic, etc.) may also be performed to further assess the pipe's characteristics and quality and test it for defects. The results of this testing (block 26) may be added (block 28) to information associated with the pipe ID. For example, database 18 may include a copy of the Material Test Report (also sometimes referred to as the Mill Test Report) associated with each pipe ID. Pipe identification information may also include an indication of whether the pipe was rejected during testing or manufacturing and, if so, the reasons for such rejection.

Pipe identification information may also include historical information about the pipe, such as its date of manufacture and shipment, and intermediate shipment or treatment destinations. Pipe identification information may be input into system 10 using a graphical user interface (GUI) on a general purpose computer, a specially adapted terminal, or other similar means. For example, data entry stations and/or screens may be located at one or more stations within the steel mill, allowing an operator at each such station to enter additional pipe identification information. Alternatively, if an RFID tag is used as external identifier (as discussed in more detail below) sensors may be set up in combination with an RFID reader. In this way, a particular characteristic of a pipe may be automatically determined or measured and that value automatically input into the data and processing storage system 14, along with the external identifier for that particular pipe. As pipe identification information is input into processing and storage system 14, it is processed and organized by software 16 (e.g., associated with the relevant pipe ID) and saved to a database (e.g., database 18 from FIG. 1) that is configured to store pipe ID and accessible to external requests for pipe information.

Once the pipe has completed the manufacturing process, the pipe ID and/or unique external identifier may be used to track the pipe within the facility of the manufacturer. A pipe manufacturer's facility is generally referred to as a “yard” and these facilities can cover extremely large areas, which often creates difficulties in effectively managing, or even locating, inventory. For example, in an embodiment using RFID tags as the unique external identifier (whether on the pipe itself or on an end cap), RFID readers could be installed at various locations around the yard to create a “smart yard.” Forklifts may be equipped with RFID readers that are configured to scan the RFID tag on every pipe that is moved around the yard. In this way, the location of each pipe would be known from the time it leaves the mill at the end of the manufacturing process until the time it is shipped out to a customer. Such real-time information can be used to automatically create inventory maps showing the location of pipes all over the yard. Other similar methods could also be used, including workers using handheld scanners, drones equipped with RFID readers, or a myriad of other ways to track each pipe using its unique external identifier.

As part of this capability to track pipes within the manufacturer's yard, one embodiment of the present invention may include an internal mobile application. In addition to allowing pipe to be tracked by scanning the unique external identifier, the internal mobile application may allow the manufacturer and its employees to update pipe identification information even after a pipe has left the steel mill. For example, if a pipe had not previously been labeled with a unique external identifier, the internal mobile application may allow an employee of the manufacturer to retroactively associate that pipe with a pipe ID in order to have it included in database 18.

The present invention can also provide benefits for the manufacturer in connection with shipping of pipes. When a pipe is shipped (block 34) out of the manufacturing site, the identifier may be scanned to update the location of the pipe. For example, a scanner may be used to scan the RFID tag of a pipe to identify the pipe and update its pipe ID to include information about when the pipe has shipped out of a site, and where the pipe is destined to be delivered. In addition, scanning unique external identifiers may allow the manufacturer to automate certain aspects of the shipping process. For example, certain shipping forms that are commonly used in the industry are still typically completed by hand, which is a very time-consuming and inefficient process. The present invention may allow the manufacturer to enter a bill of lading number and then scan each pipe, such that the information can be used to auto-populate shipping forms and automatically calculate certain parameters such as total tonnage of the pipes included within a particular shipment. Scanning of each pipe's external identifier may also allow the manufacturer to automatically cross-reference the shipment with the customer's initial order, to ensure that the proper pipes are being shipped. Once the pipe had been shipped by the manufacturer and reached its destination, the pipe identification information may then be accessed (block 20) from the database 18, as shown in FIG. 3. For example, a distributor or end user may use a scanner or reader to scan or read an external identifier of a pipe. In some embodiments, the identifier may include a barcode, a radio-frequency identification (RFID), QR code, or any unique external identifier. The scanner or other device used to read the external identifier may be in communication with a remotely located processor used to store database 18. Such communication may be via a direct connection or wireless, such as using wi-fi or Bluetooth technology. Alternatively, mobile devices may be adapted such that scanning or reading the identifier may provide immediate access to pipe identification information of the scanned pipe. For example, an application or web portal may be saved on a mobile phone or laptop which may display the associated pipe identification information once a pipe is scanned.

A recipient may use an application or web portal from a computer, such as a mobile phone or laptop, which may be integrated with a scanner used to scan the pipe. Scanning the pipe may then allow a recipient to access pipe identification information and tracking information from the database 18, through the recipient's computer. Database 18 may be cloud-based to facilitate easy remote access by customers.

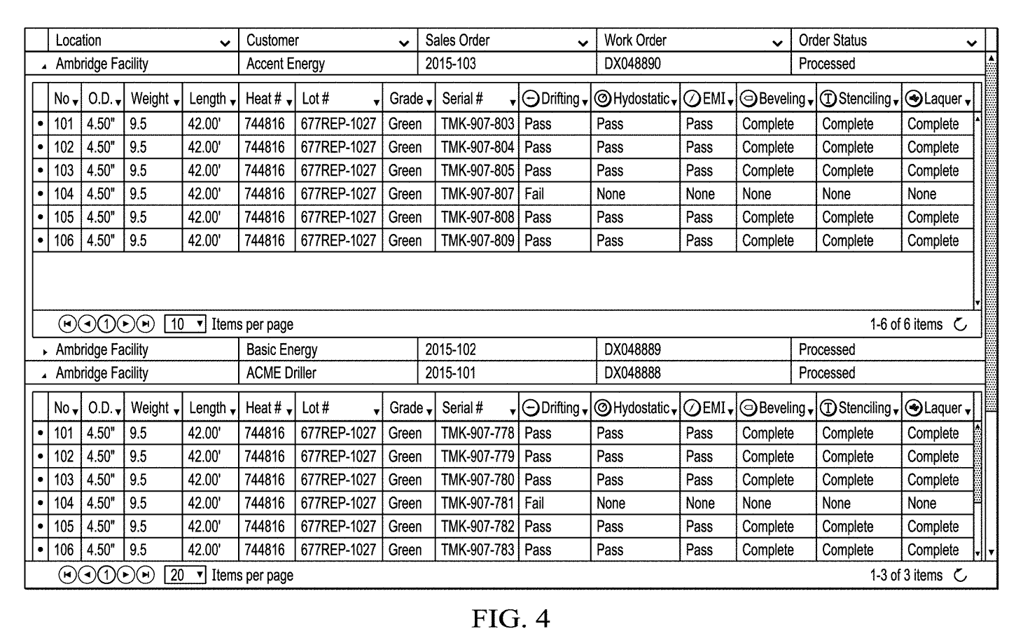

FIG. 4 is a screenshot of an example of a web application integrated with a system for identifying and tracking tubular goods. Several pipes may be scanned or read and simultaneously displayed with organized identification and historical information for each pipe.

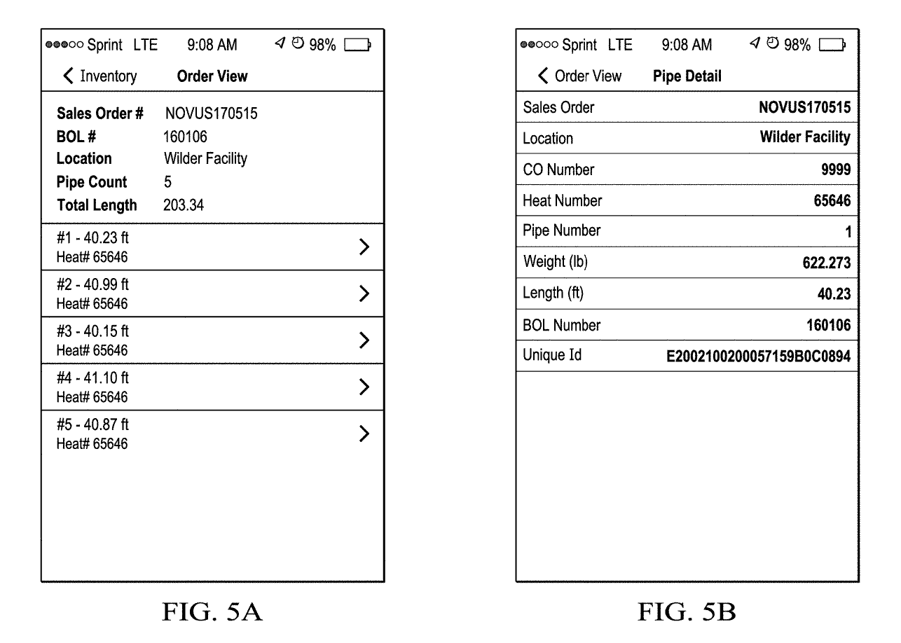

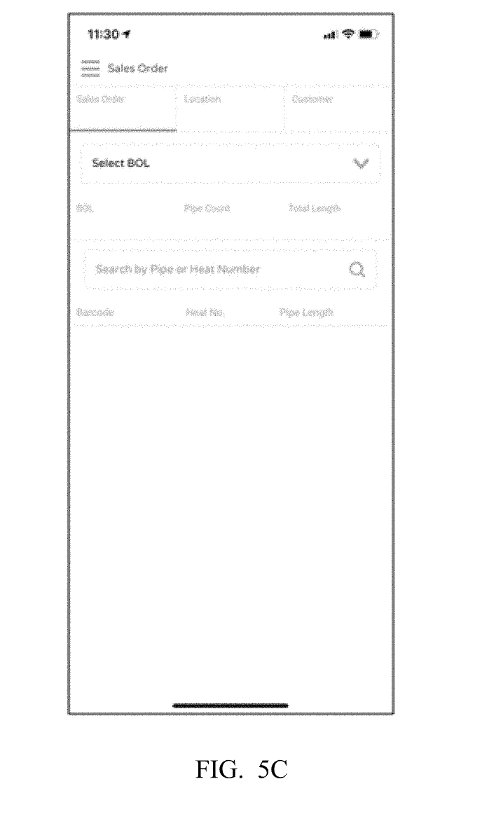

FIGS. 5A-5C are screenshots of a mobile application integrated with the present embodiments. As shown in FIG. 5A, in some embodiments, the pipe ID for several pipes may be displayed with adjustable levels of detail. Further information may also be displayed in detail for each pipe, as shown in FIG. 5B. As shown in FIG. 5C, there may be a higher level screen where the customer may select from among multiple orders before displaying information concerning individual pipes.

The web application and mobile application may each provide some combination of a number of characteristics associated with a pipe ID of each pipe. In some embodiments, the dimensions (length, weight, inner and/or outer diameters), processing data, testing data, heat treatment information, coil data (including material and composition of the pipe) may be displayed. Information related to the pipe's bill of lading (BOL) number, order number, and manufacturing and/or treatment locations and dates may be displayed.

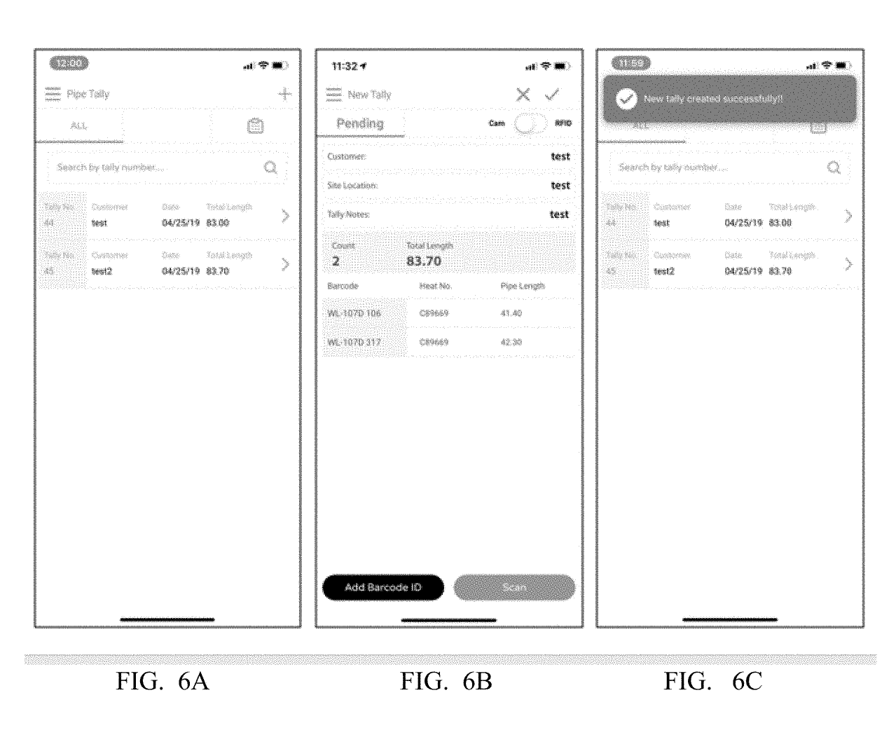

As one example, the web application and mobile application may allow customers to automatically calculate the overall length of a string of pipes by simply scanning the unique external identifier on each pipe. This is much more efficient than the current procedure of measuring each individual pipe by hand and adding up the total lengths. Examples of the screens used for this automated telling process are shown on FIGS. 6A-6C

Many modifications and other implementations set forth herein will be apparent having the benefit of the teachings presented in the foregoing descriptions and the associated drawings. Therefore, it is to be understood that the systems and methods described herein are not to be limited to the specific implementations disclosed and that modifications and other implementations are intended to be included within the scope of the appended claims. Although specific terms are employed herein, they are used in a generic and descriptive sense and not for purposes of limitation.

1. A system comprising:
a non-transitory tangible computer-readable storage medium having executable computer code stored thereon, the code comprising instructions that causes one or more processors to perform the following:
generate a pipe ID to be correlated with a pipe, wherein the pipe ID comprises an identifier unique to the pipe;
accept one or more inputs comprising pipe information concerning one or more characteristics of the pipe;
associate the pipe information with the pipe ID;
output the pipe ID and associated pipe information to one or more processors used to store a database configured to store multiple pipe IDs;
receive one of more requests comprising a pipe ID;
use the requested pipe ID to locate within the database the pipe information associated with the pipe ID; and
output the pipe information associated with the requested pipe ID.

2. The system of claim 1, wherein the pipe information comprises pipe dimensions, pipe composition, pipe treatment details, pipe testing results, pipe order number, bill of lading number, pipe manufacturing location, pipe treatment location, pipe delivery destination, or combinations thereof.

3. The system of claim 1, wherein the system is configured to accept one or more components pipe information at different times, and identify the one or more components of pipe information with the pipe ID.

4. The system of claim 1, further comprising a reader configured to read an identifier on the pipe and configured to transmit pipe information to the one or more processors, such that the pipe information is associated with the pipe ID.

5. The system of claim 4, further comprising an identifier configured to be read by the reader and configured to be associated by the one or more processors with its respective pipe ID.

6. A method comprising:
generating a pipe ID for a pipe, wherein the pipe ID comprises an identifier unique to the pipe;
storing the pipe ID in a database stored on one or more processors;
performing testing on the pipe to generate testing results;
inputting into the one or more processors said testing results; and
within said database, associating said testing results with the pipe ID and attaching an external identifier to the pipe, wherein the external identifier is associated with the pipe ID.

7. The method of claim 6, wherein generating the pipe ID comprises associating the pipe's dimensions, composition, manufacturing location, serial number, or combinations thereof, with the pipe ID.

8. The method of claim 6, wherein associating testing results with the pipe ID comprises associating testing parameters, testing descriptions, testing types, testing passage, testing results, or combinations thereof, with the pipe ID.

9. The method of claim 6, wherein attaching the external identifier comprises attaching an RFID tag to the pipe.

10. The method of claim 6, further comprising scanning the external identifier prior to shipping the pipe.

11. The method of claim 10, further comprising associating shipment information with the pipe ID, wherein scanning the identifier prior to shipping results in the shipment information.
